(19) United States
(12) Patent Application Publication
(10) Pub. No.: US 2018/0062954 A1
(43) Pub. Date: Mar. 1, 2018

(54) TELEGRAM ANALYSIS APPARATUS AND TELEGRAM ANALYSIS METHOD

(71) Applicant: HITACHI, LTD., Tokyo (JP)

(72) Inventors: Takahiro YOKOYAMA, Tokyo (JP); Shinji HAMADA, Tokyo (JP); Takashi ICHIMURA, Tokyo (JP); Noriaki TAKAHASHI, Tokyo (JP); Hirokazu MATSUMOTO, Tokyo (JP); Yoshihisa IDA, Tokyo (JP)

(21) Appl. No.: 15/557,548

(22) PCT Filed: May 22, 2015
(86) PCT No.: PCT/JP2015/064831

§ 371 Date: Sep. 12, 2017

(51) Int. Cl. H04L 12/26

(52) U.S. Cl. CPC H04L 43/045; H04L 43/0864; H04L 43/12

(57) ABSTRACT

Issuing sources of telegrams are identified on the basis of the relevance between the telegrams transmitted and received between servers. A telegram analysis method for a telegram analysis apparatus for associating telegrams with each other, which are transmitted and received between a plurality of servers connected via a network apparatus, wherein the telegram analysis method includes: a step executed by the telegram analysis apparatus capturing packets transmitted and received between the servers; a step executed by the telegram analysis apparatus identifying protocols of the packets and a telegram type indicative of either a request telegram or a response telegram, and assembling the protocols into telegrams; and a step executed by the telegram analysis apparatus associating a plurality of telegrams with each other, which are transmitted and received between the respective servers on the basis of request receipt times and response receipt times of the telegrams.

### TECHNICAL HELD

The present invention relates to a telegram analysis apparatus and a telegram analysis method and is suited for use in a telegram analysis apparatus and telegram analysis method for analyzing telegrams transmitted and received between systems.

### BACKGROUND ART

In recent years along with widespread use of APM (Application Performance Management) tools, it has been expected to provide services with unprecedented operational levels, such as to acquire seamless statistic information of back-end systems from a large amount of web screens, and provide job analysis information. It is required, as preliminary steps before providing the above-described information, to accumulate data such as telegrams and SQL on the web, shorten customers' failure analysis information, and reduce the number of analysis processes.

For example, PTL 1 aims at promoting efficiency of maintenance work of, for example, network communication by referring to a mapping table in which, for example, the correspondence relationship between telegrams running through the network, associating telegrams such as web telegrams and SQL telegrams transmitted and received between servers with each other, and determining whether the telegrams are transmitted and received normally.

### CITATION LIST

### Patent Literature

PTL 1: U.S. Pat. No. 5,420,112

### SUMMARY OF THE INVENTION

### Problems to be Solved by the Invention

When failure analysis, data analysis, and so on are performed, it is necessary to identify from which servers or applications the telegrams have been issued. However, the above-mentioned PTL 1 only associates the telegrams with each other and cannot identify issuing sources of the associated telegrams. Thus, it is necessary to identify tasks executed by each server by checking logs and tracing information of each server. Therefore, there is a problem of the incapability to shorten research time for failure analysis, data analysis, and so on.

The present invention was devised in consideration of the above-described circumstances and aims at proposing a telegram analysis apparatus and telegram analysis method capable of identifying the issuing sources of the telegrams on the basis of the relevance between the telegrams transmitted and received between the servers.

### Means to Solve the Problems

In order to solve the above-described problems, provided according to the present invention is a telegram analysis method for a telegram analysis apparatus for associating telegrams with each other, which are transmitted and received between a plurality of servers connected via a network apparatus, wherein the telegram analysis method includes: a step executed by the telegram analysis apparatus capturing packets transmitted and received between the servers; a step executed by the telegram analysis apparatus identifying protocols of the packets and a telegram type indicative of either a request telegram or a response telegram, and assembling the protocols into telegrams; and a step executed by the telegram analysis apparatus associating a plurality of telegrams with each other, which are transmitted and received between the respective servers on the basis of request receipt times and response receipt times of the telegrams.

In order to solve the above-described problems, provided according to the present invention is a telegram analysis apparatus including: a control unit that analyzes telegrams transmitted and received between a plurality of servers connected via a network apparatus; and a storage unit that stores an analysis result of the telegrams, wherein the control unit; captures packets transmitted and received between the servers; identifies protocols of the packets and a telegram type indicative of either a request telegram or a response telegram, and assembles the protocols into telegrams; and associates a plurality of telegrams with each other, which are transmitted and received between the respective servers on the basis of request receipt times and response receipt times of the telegrams.

In order to solve the above-described problems, provided according to the present invention is a telegram analysis system including: a plurality of servers connected via a network apparatus; and a telegram analysis apparatus that captures packets from the network apparatus, wherein the telegram analysis apparatus: identifies protocols of the captured packets and a telegram type indicative of either a request telegram or a response telegram, and assembles the protocols into telegrams; and associates a plurality of telegrams with each other, which are transmitted and received between the respective servers on the basis of request receipt times and response receipt times of the telegrams.

### Advantageous Effects of the Invention

According to the present invention, the system can be visualized without making changes to the servers or telegrams by identifying the issuing sources of the telegrams on the basis of the relevance between the telegrams transmitted and received between the servers.

### BRIEF DESCRIPTION OF DRAWINGS

FIG. 1 is a block diagram illustrating a hardware configuration of a telegram analysis apparatus according to a first embodiment of the present invention.

FIG. 2 is a block diagram illustrating a functional configuration of the telegram analysis apparatus according to the above-mentioned embodiment.

FIG. 3 is a chart illustrating an example of a telegram protocol list according to the above-mentioned embodiment.

FIG. 4 is an explanatory diagram for explaining associating telegrams according to the above-mentioned embodiment.

FIG. 5 is a flowchart illustrating the details of telegram associating processing according to the above-mentioned embodiment.

FIG. 6 is a chart illustrating an example of an application list according to the above-mentioned embodiment.

FIG. 7 is a chart illustrating the details of application associating processing according to the above-mentioned embodiment.

FIG. 8 is a conceptual diagram illustrating an http request list display screen example according to the above-mentioned embodiment.

FIG. 9 is a conceptual diagram illustrating a time-series display screen example according to the above-mentioned embodiment.

FIG. 10 is a conceptual diagram illustrating a detailed telegram display screen example according to the above-mentioned embodiment.

FIG. 11 is a conceptual diagram for explaining the outlines of a second embodiment of the present invention.

FIG. 12 is a conceptual diagram for explaining the outlines of telegram associating processing according to the above-mentioned embodiment.

FIG. 13 is a flowchart illustrating the telegram associating processing according to the above-mentioned embodiment.

FIG. 14A is a conceptual diagram illustrating an example of an association list according to the above-mentioned embodiment.

FIG. 14B is a conceptual diagram illustrating an example of an application list according to the above-mentioned embodiment.

FIG. 14C is a conceptual diagram illustrating an example of a telegram list according to the above-mentioned embodiment.

### DESCRIPTION OF EMBODIMENTS

An embodiment of the present invention will be explained in detail below with reference to the drawings.

### (1) First Embodiment

### (1-1) Outline of the Present Embodiment

Firstly, the outline of the present embodiment will be explained. Recently, there have been demands to accumulate data such as telegrams and SQL on the web, shorten clients' failure analysis information, and reduce the number of analysis processes. Thus, the present embodiment makes it possible to visualize a system without adding any changes to servers or telegrams by identifying issuing sources of the telegrams on the basis of the relevance between the telegrams transmitted and received between the servers.

For example, when any problem such as a response delay occurs in a web system, it is necessary to identify a server or task which had the problem. In the present embodiment, the issuing sources of the telegrams are identified by analyzing protocols and telegram types of the telegrams (packets) running between the respective servers in the web system and associating the telegrams with each other.

Specifically speaking, examples of servers for the web system include web servers, AP servers, and DB servers: and packets running between the respective servers are captured by utilizing a mirroring function of network switches located between a client and a web server, between the web server and an AP server, and between the AP server and a DB server. Then, telegrams are assembled by identifying the protocols of the packets and the telegram type (either a request telegram or a response telegram) and the telegrams are associated with each other on the basis of request telegram receipt times and the response telegram receipt times of the assembled telegrams. According to the present embodiment as described above, it becomes possible to identify the issuing sources of the telegrams on the basis of telegram associating information without adding any changes to the servers or the telegrams and shorten research time for failure analysis, data analysis, and so on.

Furthermore, in the present embodiment, an application which has issued the relevant telegram is also identified on the basis of key information included in the telegram. It becomes possible to execute, for example, more detailed failure analysis and data analysis by associating applications with each other by combining the above-mentioned telegram associating information with information about the applications which have issued the telegrams.

### (1-2) Configuration of Telegram Analysis Apparatus

### (1-2-1) Hardware Configuration

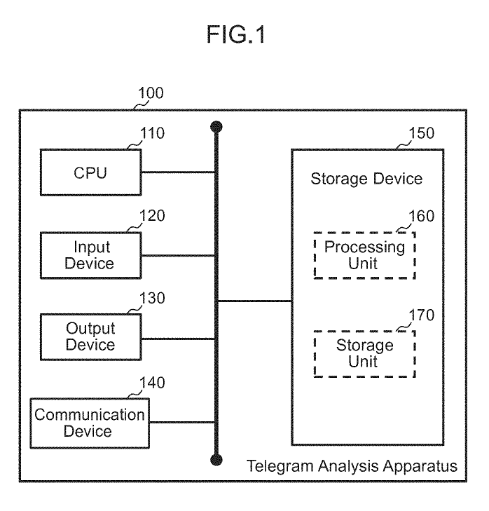

Next, a hardware configuration of a telegram analysis apparatus 100 will be explained with reference to FIG. 1. Incidentally, since a client 10, a web server 20, an AP server 30, and a DB server 40 which will be described later are almost the same as the hardware configuration of the telegram analysis apparatus 100, any detailed explanation about them has been omitted.

An explanation will be given below about a case where the telegram analysis apparatus 100 analyzes telegrams running through the web system; however, without limitation to such an example, the telegrams can be analyzed by applying the present invention to a system other than the web system as long as there are three or more types of devices including the client 10 and the telegrams between the devices are according to protocols for transmitting request and response telegrams. For example, the present invention can be applied to an OLTP (Online Transaction Processing) system.

Referring to FIG. 1, the telegram analysis apparatus 100 is composed of a CPU 110, an input device 120, an output device 130, a communication device 140, a storage device 150, and so on.

The CPU 110 functions as an arithmetic processing unit and a control apparatus and controls the entire operation of the telegram analysis apparatus 100 in accordance with various programs.

The input device 120 is composed of, for example, input means for a user to enter information such as a mouse, a keyboard, a touch panel, buttons, a microphone, switches, and levers and an input control circuit for generating an input signal according to the user's inputs and outputting the input signal to the CPU 110.

The output device 130 is composed of, for example, display devices such as a CRT (Cathode Ray Tube) display device, a liquid display (LCD) device, an OLED (Organic Light Emitting Display) device, and lamps and sound output devices such as a speaker and a headphone.

The communication device 140 is, for example, a communication interface composed of a communication device for connecting to a network. Moreover, the communication device 140 may be a wireless LAN (Local Area Network) compatible communication device, a wireless USB compatible communication device, or a wired communication device for performing wired communication.

The storage device 150 is storage media such as a RAM (Read Access Memory) and a ROM (Read Only Memory). The storage device 150 stores a processing unit 160 storing programs for executing various processing and a storage unit 170 storing various data and tables, etc.

### (1-2-2) Functional Configuration

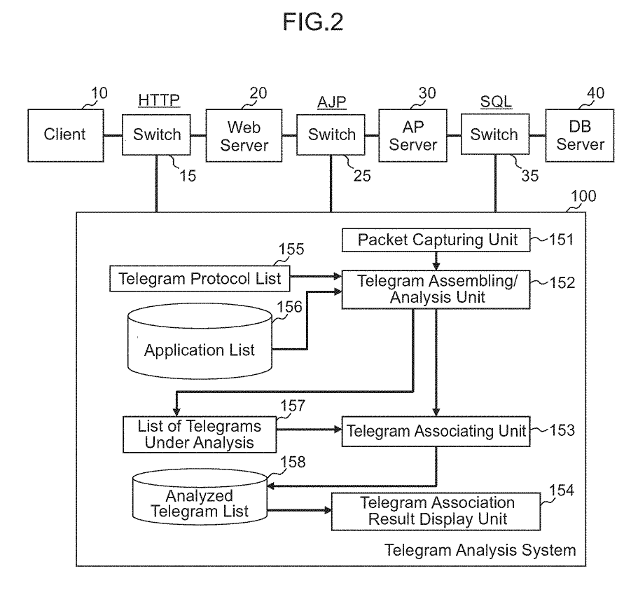

Next, a functional configuration of the telegram analysis apparatus 100 will be explained with reference to FIG. 2. Incidentally, various programs described below for activating the CPU 110 as a functional unit are stored in the processing unit 160 for the storage device 150 and various data are stored in the storage unit 170.

Referring to FIG. 2, the telegram analysis apparatus 100 includes a packet capturing unit 151, a telegram assembling/analysis unit 152, a telegram associating unit 153, a telegram association result display unit 154, a telegram protocol list 155, an application list 156, a list of telegrams under analysis 157, and an analyzed telegram list 158.

The packet capturing unit 151 acquires packets running between the respective servers and provides the telegram assembling/analysis unit 152 with the acquired packets. Referring to FIG. 2, the packet capturing unit 151 copies and captures the packets running between the respective servers by utilizing the mirroring function of network switches 15, 25, and 35 located between a client 10 and a web server 20, between the web server 20 and an AP server 30, and between the AP server 30 and a DB server 40. Incidentally, the network switches are taken as an example of the network apparatus of the present invention; however, the network apparatus is not limited to the network switches and may be any device having the same function.

The telegram assembling/analysis unit 152 assembles a telegram by identifying a protocol and telegram type of the relevant packet and acquires request telegram receipt time and response telegram receipt time of the assembled telegram. Specifically speaking, the telegram assembling/analysis unit 152 identifies the protocol and the telegram type of the packet on the basis of a source IP address and a destination IP address included in the telegram by referring to the telegram protocol list 155 prepared in advance. The telegram type means whether the target telegram is a request telegram or a response telegram.

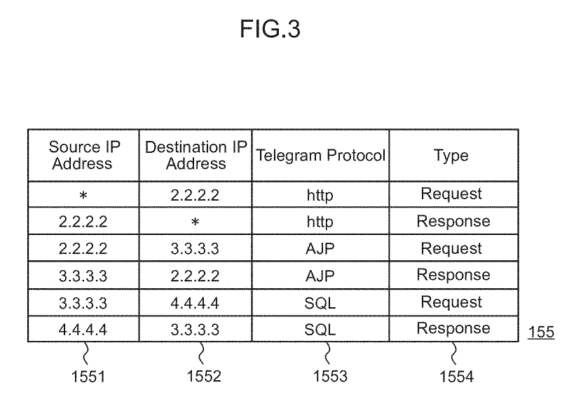

Now, the telegram protocol list 155 will be explained with reference to FIG. 3. FIG. 3 is a chart illustrating an example of the telegram protocol list 155. The telegram protocol list 155 is information designated by the user in advance and a source IP address 1551, a destination IP address 1552, a telegram protocol 1553, and a type 1554 are made to correspond to each other as illustrated in FIG. 3.

The source IP address 1551 is information about a source of the relevant packet and the destination IP address 1552 is information about a destination of the relevant packet. The protocol 1553 is a protocol between the relevant servers and includes, for example, an http protocol between the client 10 and the web server 20, an AJP protocol between the web server 20 and the AP server 30, and an SQL protocol between the AP server 30 and the DB server 40. The type 1554 shows the type of the relevant telegram and examples of the type include a request telegram and a response telegram.

The telegram assembling/analysis unit 152 extracts the source IP address and the destination IP address of the acquired packet and identifies the protocol and the type corresponding to the extracted IP addresses by referring to the telegram protocol list 155. For example, when the source IP address is “2.2.2.2” and the destination IP address is “3.3.3.3,” the protocol can be identified as “AJP” and the type can be identified as a “request.”

Then, the telegram assembling/analysis unit 152 identifies the protocol and the type, assembles the packet into a telegram, acquires the request receipt time and the response receipt time of the assembled telegram, and stores them in the list of telegrams under analysis 157.

The telegram associating unit 153 associates telegrams with each other on the basis of request telegram receipt times and response telegram receipt times of the telegrams assembled by the telegram assembling/analysis unit 152. Specifically speaking, the telegram associating unit 153 compares the request telegram receipt times and the response telegram receipt times of the respective protocols which are stored in the list of telegrams under analysis 157 and determines that the http protocol, the AJP protocol, and the SQL protocol which satisfy the following Condition 1 and Condition 2 are related to each other.

(Condition 01) An AJP telegram whose request and response times are acquired between the request and response times of an http telegram
(Condition 02) An SQL telegram whose request and response times are acquired between the request and response times of the kW telegram

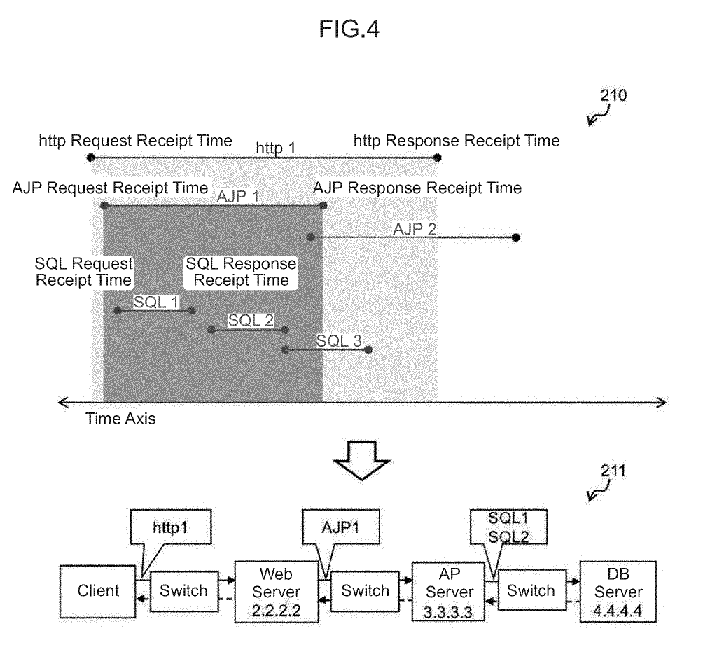

Associating telegrams by the telegram associating unit 153 will be explained with reference to FIG. 4. FIG. 4 is an explanatory diagram 210 and an explanatory diagram 211 for explaining the association between telegrams.

As shown in the explanatory diagram 210 of FIG. 4, request and response telegrams of AJP1 are acquired and request and response telegrams of AJP2 are not acquired between request and response times of http1. The explanatory diagram 210 shows that request and response telegrams of SQL1 and SQL2 are acquired and request and response telegrams of SQL3 are not acquired between request and response times of AJP1.

Therefore, http1, AJP1, SQL1 and SQL2 can be associated with each other; and the explanatory diagram 211 of FIG. 4 shows that SQL1 and SQL2 are executed via AJP1 as a continuation of the telegram http1 requested by the client 10. The telegram associating unit 153 stores the analyzed and associated telegrams hi the analyzed telegram list 158.

Furthermore, the telegram associating unit 153 identifies applications which have issued telegrams on the basis of key information included in the telegrams. Specifically speaking, the telegram associating unit 153 associates the applications by referring to the application list 156 prepared in advance. The application list 156 and the association between the applications will be explained later in detail.

The telegram association result display unit 154 displays the results of telegram association by the telegram associating unit 153 on a display screen in response to the user's request. The telegram association result display unit 154 displays the associated telegrams on an http request basis. As a result, the user can get a full picture of the captured http telegrams.

It is also possible to identify, for example, a problematic task(s) from information of the applications corresponding to http telegrams by chronologically displaying AJP telegrams and SQL telegrams which are associated with http requests and displaying detailed information about each telegram. Display screen examples displayed by the telegram association result display unit 154 will be explained later hi detail. Incidentally, in the present embodiment, the telegram association result display unit 154 is a component of the telegram analysis apparatus 100; however, the invention is not limited to this example and the telegram association result display unit 154 may be configured as a display device separate from the telegram analysis apparatus 100.

### (1-3) Details of Telegram Associating Processing

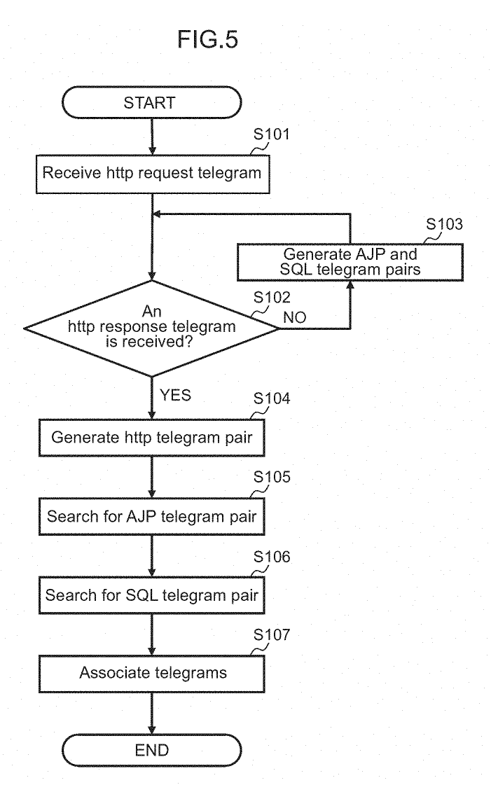

Next, the details of telegram associating processing by the telegram associating unit 153 will be explained with reference to FIG. 5. Referring to FIG. 5, after receiving an http request telegram (S101), the telegram associating unit 153 determines whether a response telegram for the http received in step S101 is received or not (S102).

When it is determined in step S102 that the http response telegram is received, the telegram associating unit 153 executes processing in step S104 and subsequent steps. On the other hand, when it is determined in step S102 that the http response telegram has not been received yet, the telegram associating unit 153 generates a pair of an AJP telegram and an SQL telegram (S103).

When the telegram received in step S103 is a request telegram, the telegram associating unit 153 stores the request telegram until it receives a response telegram which forms a pair with the request telegram. Then, when the received telegram is a response telegram, the telegram associating unit 153 generates a telegram pair by pairing the response telegram with the target request telegram if the following conditions are satisfied.

(Condition 11) Receipt time is earlier than that of the target response telegram.
(Condition 12) Source IP address of the target response telegram=destination IP address of the request telegram
(Condition 13) Destination IP address of the target response telegram=source IP address of the request telegram

In step S104, the telegram associating unit 153 searches for a pair for the received http response telegram and generates an http telegram pair in the same manner as in step S103 above (S104).

The telegram associating unit 153 searches for an MP telegram pair to be associated with the http telegram pair generated in step S104 (S105). Specifically speaking, the telegram associating unit 153 searches for the MP telegram pair to be associated with the http telegram pair under the following search conditions.

(Condition 21) Request telegram receipt time of the target http telegram pair<request telegram receipt time of AJP telegram pair
(Condition 22) Response telegram receipt time of the target http telegram pair>response telegram receipt time of kW′ telegram pair
(Condition 23) Destination IP address of the http request telegram=source IP address of AJP telegram

Subsequently, the telegram associating unit 153 searches for an SQL telegram pair to be associated with the AJP telegram pair associated with the target http telegram pair in step S105 (S106). Specifically speaking, the telegram associating unit 153 searches for the SQL telegram pair to be associated with the AJP telegram pair under the following search conditions.

(Condition 31) Request telegram receipt time of AJP telegram pair<request telegram receipt time of SQL telegram pair
(Condition 32) Response telegram receipt time of AJP telegram pair>response telegram receipt time of SQL telegram pair
(Condition 33) Destination IP address of AJP request telegram=source IP address of SQL telegram

The telegram associating unit 153 associates the target http telegram pair with the AJP telegram pair and the SQL telegram pair, which are found by the searches in step S105 and step S106, and stores them in the analyzed telegram list 158 (S107).

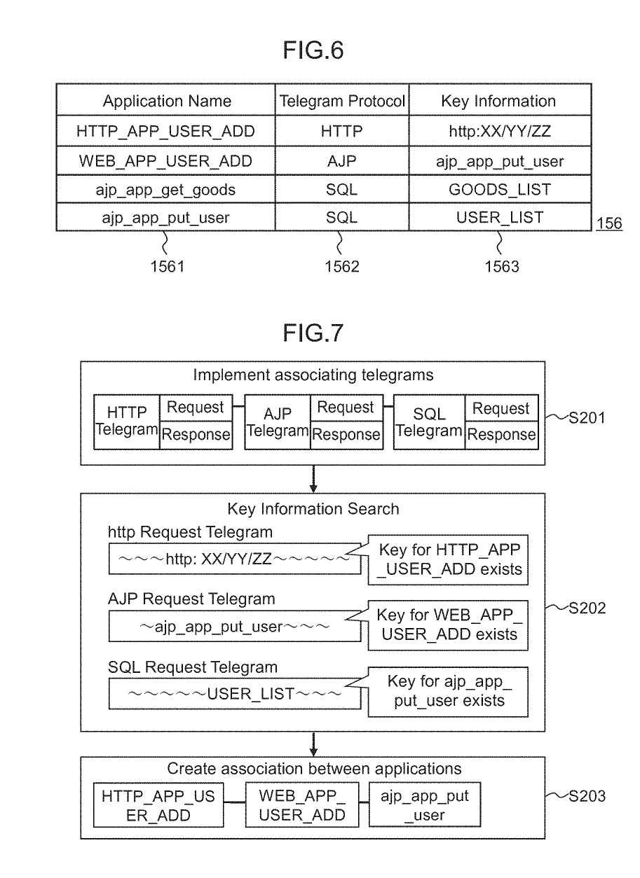

Next, the association between applications will be explained with reference to FIG. 6 and FIG. 7. Regarding the association between applications as mentioned above, the telegram associating unit 153 associates the applications with each other on the basis of the key information included in the telegrams by referring to the application list 156 prepared in advance.

The application list 156 will be explained with reference to FIG. 6. An application name 1561, a telegram protocol 1562, and key information 1563 are associated with each other in the application list 156 as illustrated in FIG. 6. The application name 1561 is information indicative of the name of the relevant application; and the telegram protocol 1562 is a protocol used for a telegram issued by the target application. The key information 1563 is information which is included in the relevant telegram and is capable of uniquely identifying the application.

Regarding the key information 1563, for example, a URL may be key information for an http telegram, an application name on an AP server may be key information for an AJP telegram, and a database name on a DB server may be key information for an SQL telegram.

FIG. 6 shows that when the telegram protocol is an http telegram and key information “http: XX/YY/ZZ” is included in the telegram, the relevant application is “HTTP_APP_USER_ADD.” Furthermore, FIG. 6 shows that when the telegram protocol is an AJP telegram and key information “ajp_app_put_user” is included in the telegram, the relevant application is “WEB_APP_USER_ADD.” Furthermore, when the telegram protocol is an SQL telegram and key information “USER_LIST” is included in the telegram, the relevant application is “ajp_app_put_user.”

Next, the details of the application associating processing by the telegram associating unit 153 will be described with reference to FIG. 7. Referring to FIG. 7, the telegram associating unit 153 executes association between the telegrams by the above-described telegram associating processing as illustrated in FIG. 5 (S201), then refers to the application list 156, and searches for the key information included in the telegrams associated in step S201 (S202). Subsequently, the telegram associating unit 153 associates applications with each other, which correspond to the key information found in the search in step S202 (S203).

Specifically speaking, for example, when “http: XX/YY/ZZ” is included in an http request telegram, the telegram associating unit 153 identifies that an application which is its issuing source is “HTTP_APP_USER_ADD.” Furthermore, when “ajp_app_put_user” is included in an AJP request telegram, the telegram associating unit 153 identifies that an application which is its issuing source is “WEB_APP_USER_ADD,” Furthermore, when “USER_LIST” is included in an SQL request telegram, the telegram associating unit 153 identifies that an application is “ajp_app_put_user.” Then, the telegram associating unit 153 associates these identified applications with each other and stores them.

### (1-4) Display of Telegram Association Results

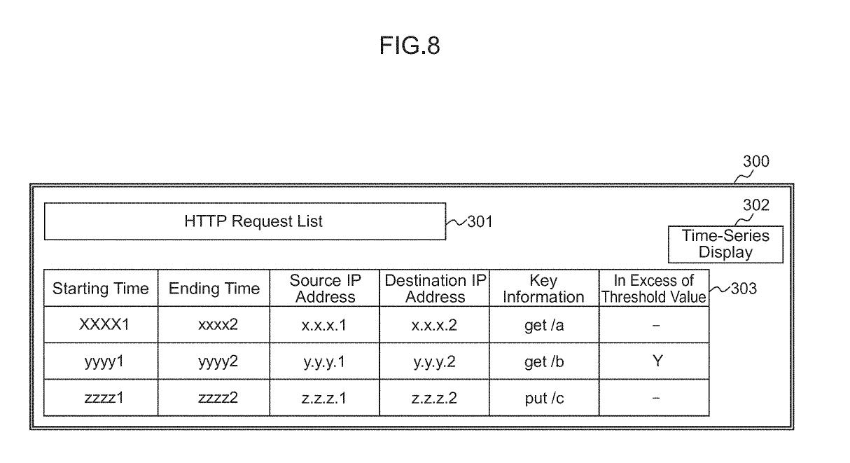

Next, display examples of the telegram and application association results by the above-mentioned telegram associating processing will be explained. FIG. 8 to FIG. 10 are display screen examples displayed by the telegram association result display unit 154.

FIG. 8 is a display screen example which displays the content of http telegrams regarding which the association between the telegrams are analyzed when an http request list 301 is selected by the user. Referring to FIG. 8, the telegram association result display unit 154 extracts request/response telegram pairs whose protocol is http from the analyzed telegram list 158, extracts necessary information for the screen display, and displays an http request list display example 303.

The http request list display example 303 displays starting time, ending time, a source IP address, a destination IP address, and key information of the relevant http protocol extracted from the analyzed telegram list 158. Moreover, when response time (ending time−starting time) of the protocol exceeds a specified threshold value, “Y” indicating that the response time exceeds the threshold value may be displayed in a threshold value excess column. The user can get a full picture of the captured http telegrams and which http telegram(s) had a problem, according to the http request list display example 303.

If the user wishes to check AJP telegrams and SQL telegrams associated with the http telegrams displayed on the http request list display example 303, the user selects a time-series display 302. When the time-series display 302 is selected by the user, the telegram association result display unit 154 extracts AJP telegrams associated with the http telegrams and also extracts SQL telegrams associated with the AJP telegrams from the analyzed telegram list 158 and displays the associated telegrams on the time-series display screen 310 on a time axis basis.

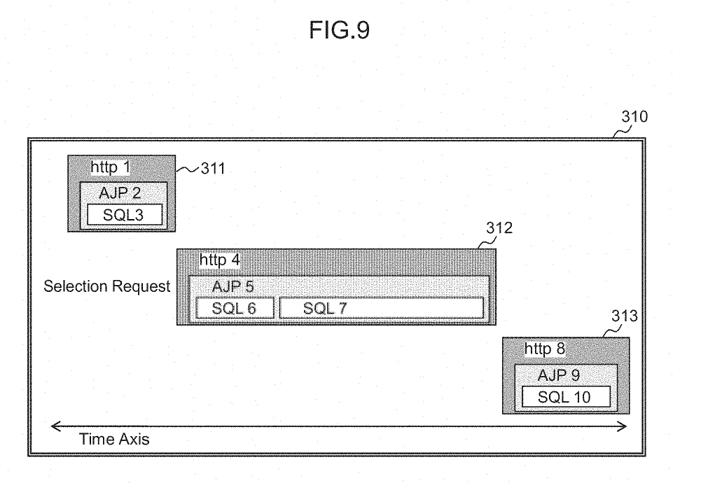

The time-series display screen 310 displays the http telegrams, the AJP telegrams, and the SQL telegrams so that the association between them can be recognized as illustrated in FIG. 9. Specifically speaking, the time-series display screen 310 displays each telegram in a frame along the time axis and one end of the frame represents the request telegram receipt time and the other end of the frame represents the response telegram receipt time. For example, an associated telegram display 311 shows that http1 AJP2, and SQL3 are associated with each other and a frame of AJP2 is set within the frame formed of the request telegram receipt time and the response telegram receipt time of http1. Then, a frame of SQL3 is set within the frame formed of the request telegram receipt time and the response telegram receipt time of AJP2.

Furthermore, when any one of the associated telegram display frames displayed on the time-series display screen 310 is selected by the user, the telegram association result display unit 154 displays a detailed telegram display screen 320 which displays the details of the selected telegram and an application corresponding to the selected telegram.

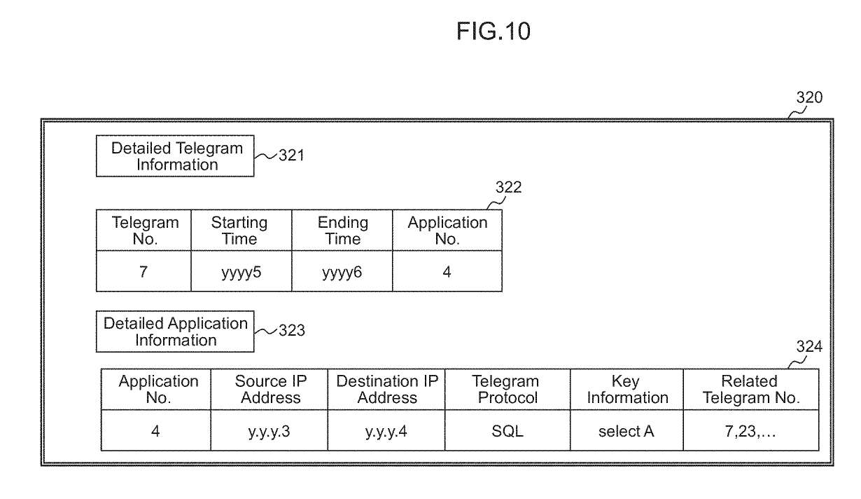

Referring to FIG. 10, the detailed telegram display screen 320 displays information 322 about the application corresponding to the selected telegram and detailed information 324 about the application. The telegram association result display unit 154 acquires the information about the application corresponding to the selected telegram from the analyzed telegram list 158 and displays the information 322 about the application by associating it with the telegram information. Furthermore, the telegram association result display unit 154 displays, for example, a source IP address, destination IP address, protocol, key information, and related telegram numbers of the application as the detailed information 324 about the application,

You can tell from FIG. 9 that the processing of SQL7 is delayed substantially, by identifying the applications associated with the telegrams as described above. Therefore, it becomes possible to identify the application corresponding to SQL7 and identify which task had a problem.

### (1-5) Advantageous Effects of the Present Embodiment

According to the present embodiment, the protocol of the relevant packet transmitted and received between the respective servers and its telegram type indicating whether it is a request telegram or response telegram are identified, the protocol is assembled into a telegram, and a plurality of telegrams transmitted and received between the respective devices are associated with each other on the basis of request receipt times and response receipt times of the telegrams. As a result, the issuing sources of the telegrams can be identified on the basis of the relevance between the telegrams transmitted and received between the servers and the system can be visualized without adding changes to the servers or the telegrams.

For example, any delayed telegram(s) can be recognized on the time-series display screen 310 illustrated in FIG. 9 by chronologically displaying the list of associated http telegrams on the basis of the above-described relevance between the telegrams. Furthermore, information about an application(s) which caused the delay of the telegram(s) can be acquired by selecting the delayed telegram(s) and displaying it on the detailed telegram display screen 320 illustrated in FIG. 10.

Since the IP address of a machine with a problem can be identified from the detailed application information in FIG. 10, it is only necessary to check the one identified machine with respect to machines regarding which logs and tracing information should be checked. When the association between the telegrams cannot be identified and the application which caused the problem cannot be identified unlike the case described above, it has been required to check the logs and tracing information with respect to all machines. Therefore, it is possible to reduce the time substantially to identify the task which had the problem, by executing the telegram associating processing according to the present embodiment.

### (2) Second Embodiment

### (2-1) Outlines of the Present Embodiment

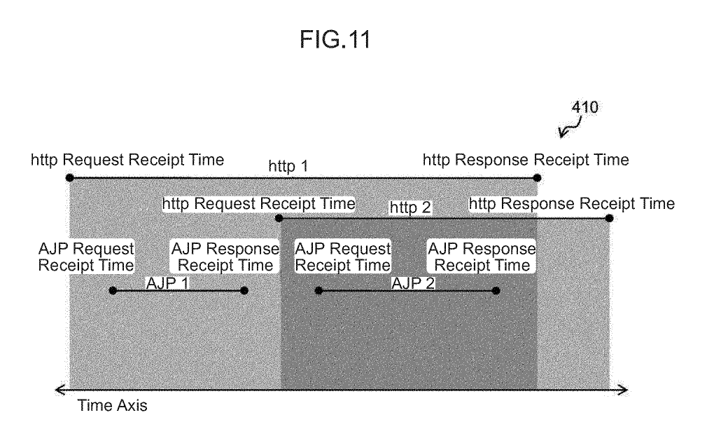

The first embodiment has been described about the case where there are only one http telegram and one AJP telegram in the same time slot; however, in the present embodiment, an explanation will be given about a case where there are pluralities of http telegrams and AJP telegrams in the same time slot. When there are pluralities of http telegrams and AJP telegrams in the same time slot, the association between telegrams cannot be sometimes uniquely decided. The case where the association between telegrams cannot be uniquely decided will be explained with reference to FIG. 11.

For example, when request-to-response receipt time of http1 overlaps with request-to-response receipt time of http2 as illustrated in FIG. 11, with which http telegram an AJP telegram is associated cannot sometimes uniquely deckled. Specifically speaking, you can see that AJP1 is associated with http1 under the aforementioned Conditions 21 to 23 and AJP2 is associated with both http1 and http2 under the aforementioned Conditions 21 to 23. In the present embodiment, the association between the telegrams can be uniquely decided even in the above-described case. This will be explained below in detail.

Incidentally, since the telegram analysis apparatus 100 according to the present embodiment has the same configuration as that of the first embodiment, any detailed explanation about it has been omitted. In the following explanation, the details of telegram associating processing by the telegram associating unit 153 which is different from the first embodiment will be explained,

### (2-2) Details of Telegram Associating Processing

The telegram associating processing explained below is premised on that functions which call applications have no difference in the same applications even if telegrams which call those applications are different from each other. That is, the present embodiment is based on the premise that a telegram issued from an application 1 is associated with a telegram issued from an application 2.

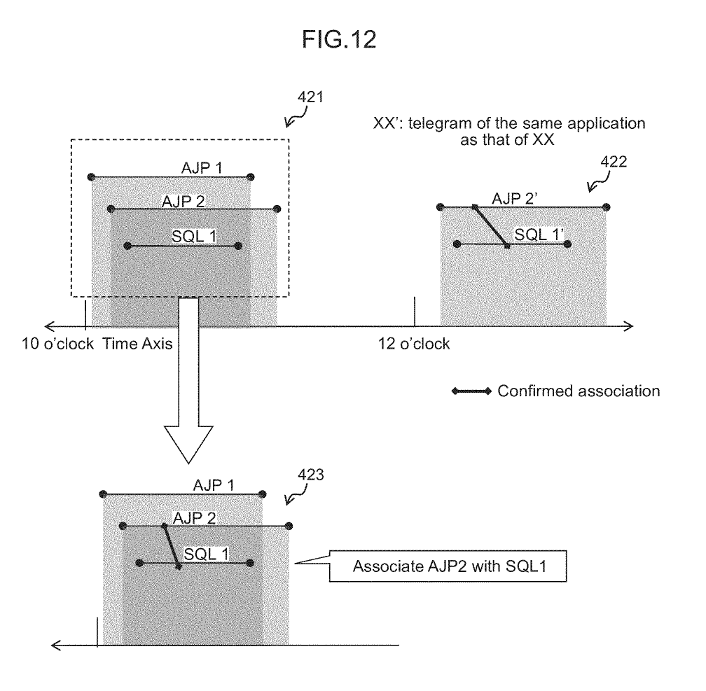

The outline of the telegram associating processing according to the present embodiment will be explained with reference to FIG. 12. In FIG. 12, AJP1, AJP2, and SQL1 are captured at around 10 o'clock; as described above, since the request-to-response receipt time of AJP1 overlaps with the request-to-response receipt time of AJP2, the AJP telegrams and an SQL telegram cannot be associated with each other. Afterwards, FIG. 12 shows that AJP2′ and SQL1′ are captured at around 12 o'clock and the association between AJP2′ and SQL1′ is confirmed.

Under this circumstance, it is assumed that applications of AJP2′ and AJP2 are the same application and applications of SQL1 and SQL1 are the same application. In this case, if the association between AJP2′ and SQL1 is confirmed, it is possible to confirm the association between AJP2′ and SQL1′ which has been unconfirmed.

Accordingly, in the present embodiment, even when the request-to-response receipt time overlaps with that of another telegram and the association between the telegrams cannot be thereby uniquely decided, the relevant telegrams can be associated with each other by utilizing a combination of applications for other telegrams,

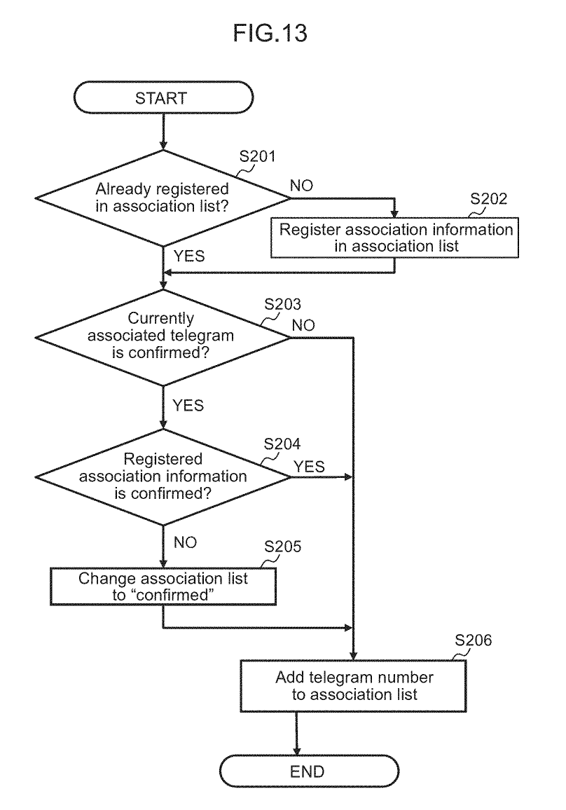

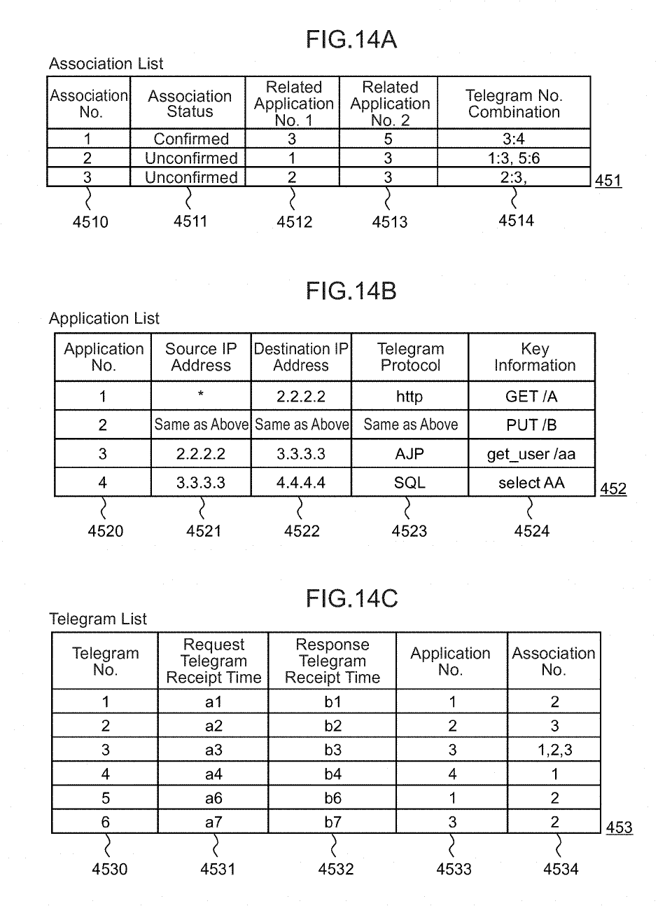

The details of the telegram associating processing according to the present embodiment will be explained with reference to FIGS. 13 and 14. FIG. 13 is a flowchart illustrating the telegram associating processing according to the present embodiment. FIGS. 14A, 14B and 14C are lists used to associate telegrams with each other.

Referring to FIG. 13, the telegram associating unit 153 firstly determines whether the associated telegrams have already been registered in an association list 451 or not (S201). Now, the association list 451, an application list 452, and a telegram list 453 will be explained.

The association list 451 is a list for managing applications related to the associated telegrams as “related applications”; and an association number 4510, an association status 4511, related application No. 1 4512, related application No. 2 4513, and a telegram number combination 4514 are associated with each other as illustrated in FIG. 14A.

The association number 4510 is the number indicative of an association item number. The association status 4511 is information indicating whether the association is confirmed or unconfirmed. The related application No. 1 4512 and the related application No. 2 4513 are numbers for identifying applications included in the associated telegrams. The telegram number combination 4514 is information indicating a combination of the associated telegrams. The combined telegrams in the telegram number combination 4514 are stored as the same combination when the application information of two associated telegrams is identical to each other.

When the associating unit 153 captures new telegrams and associates the telegrams with each other as described above, it registers a combination of the telegram numbers of the associated telegrams in the association list 451. When the telegram numbers of the associated telegrams are paired and the application information of the two associated issuing sources is identical to each other, the combination of the telegram numbers is registered in the telegram number combination 4514.

The application list 452 is a list for managing the detailed information about applications and an application number 4520, a source IP address 4521, a destination IP address 4522, a telegram protocol 4523, and key information 4524 are associated with each other as illustrated in FIG. 14B.

The application number 4520 is a number for identifying an application included in the captured telegram. The source IP address 4521 is information about a source IP address of a telegram which is an issuing source of the application. The destination IP address 4522 is information about a destination IP address of the telegram which is the issuing source of the application. The protocol 4523 is information about a protocol type of the telegram which is the issuing source of the application. The key information 4524 is key information of the relevant application.

The telegram list 453 is a list of captured telegrams and a telegram number 4530, request telegram receipt time 4531, response telegram receipt time 4532, an application number 4533, and an association number 4534 are associated with each other as illustrated in FIG. 14C.

The telegram number 4530 is a number for identifying the captured telegram. The request telegram receipt time 4531 is receipt time of a request telegram and the response telegram receipt time 4532 is receipt time of a response telegram. The application number 4533 is a number for identifying an application which is identified on the basis of the key information included in the telegram. The association number 4534 is a number indicative of the association item number of the association list 451.

Referring back to FIG. 13, when it is determined in step S201 that the associated telegrams have already been registered in the association list, the associating unit 153 executes the processing in step S203 and subsequent steps. On the other hand, when it is determined in step S201 that the associated telegrams have not been registered in the association list, the associating unit 153 registers the association information in the association list 451 (S202). Specifically speaking, the associating unit 153 adds the application information of the associated telegrams and the association status in the association list 451 in step S202.

In step S203, the associating unit 153 determines whether the association between telegrams which are the current targets to be associated with each other is confirmed or not (S203). If it is determined in step S203 that the association between telegrams which are the current targets to be associated with each other cannot be uniquely decided and is unconfirmed, the associating unit 153 adds the combination of the telegram numbers to the telegram number combination 4514 of the association list 451 (S206).

Meanwhile, if it is determined in step S203 that the association between the telegrams which are the current targets to be associated with each other is confirmed, the associating unit 153 determines whether the same association in the association list 451 is confirmed or not (S204). Specifically speaking, the associating unit 153 refers to the association list 451 and checks if the association status of the same association number as that of the current associated telegrams is “confirmed” or “unconfirmed.”

If it is determined in step S204 that the same association in the association list 451 is confirmed, the associating unit 153 adds the combination of the telegram numbers of the current associated telegrams to the telegram number combination 4514 of the association list 451 (S206).

On the other hand, if it is determined in step S204 that the same association in the association list 451 is unconfirmed, the associating unit 153 changes “unconfirmed” in the corresponding association status 4511 to confirmed (S205) and adds the combination of the telegram numbers of the current associated telegrams to the telegram number combination 4514 of the association list 451 (S206).

For example, let us assume that telegram list No. 5 and telegram list No. 6 in the telegram list 453 in FIG. 14C are associated with each other and their association status is confirmed. The telegram list 453 shows that the application number of the issuing source of the telegram list No. 5 is 1 and the application number of the issuing source of the telegram list No. 6 is 3,

Then, the association list 451 in FIG. 14A shows that the association number regarding which the related application No. 1 is 1 and the related application No. 2 is 3 can be identified as 2 and the association status of association No. 2 is unconfirmed. Thus, the associating unit 153 changes the association status of association No. 2 in the association list 451 to confirmed and adds “5:6” to the telegram number combination 4514 by pairing a telegram No. 5 and a telegram No. 6.

### (2-3) Advantageous Effects of the Present Embodiment

When there are pluralities of http telegrams and AJP telegrams in the same time slot as described above and even if the association between the telegrams cannot be uniquely decided, the association between the telegrams can be uniquely decided on the basis of the correspondence relationship between the applications according to the present embodiment. As a result, it becomes possible to enhance the accuracy of the association between the telegrams and execute, for example, more detailed failure analysis and data analysis.

### REFERENCE SIGNS LIST

100 Telegram analysis apparatus
120 Input device
130 Output device
140 Communication device
150 Storage device
151 Packet capturing unit
152 Telegram assembling/analysis unit
153 Telegram associating unit
154 Telegram association result display unit
155 Telegram protocol list
156 Application list
157 List of telegrams under analysis
158 Analyzed telegram list
160 Processing unit
170 Storage unit

1. A telegram analysis method for a telegram analysis apparatus for associating telegrams with each other, which are transmitted and received between a plurality of servers connected via a network apparatus,
the telegram analysis method comprising:
a step executed by the telegram analysis apparatus capturing packets transmitted and received between the servers;
a step executed by the telegram analysis apparatus identifying protocols of the packets and a telegram type indicative of either a request telegram or a response telegram, and assembling the protocols into telegrams; and
a step executed by the telegram analysis apparatus associating a plurality of telegrams with each other, which are transmitted and received between the respective servers on the basis of request receipt times and response receipt times of the telegrams.

2. The telegram analysis method according to claim 1, further comprising a step executed by the telegram analysis apparatus comparing the request receipt times and the response receipt times of the protocols and associating the plurality of telegrams with each other, which are transmitted and received between the servers.

3. The telegram analysis method according to claim 2, further comprising a step executed, when the telegram analysis apparatus acquires another protocol between request receipt time and response receipt time of one protocol as a result of the comparison of the request receipt times and the response receipt times of the protocols, by the telegram analysis apparatus associating the one protocol with the other protocol.

4. The telegram analysis method according to claim 1, further comprising a step executed, when response time of a telegram calculated from the request receipt time and the response receipt time of the telegram exceeds a specified threshold value, by the telegram analysis apparatus judging that the telegram is abnormal.

5. The telegram analysis method according to claim 1, further comprising a step executed by the telegram analysis apparatus identifying an application which is an issuing source of the telegram on the basis of key information in the telegram.

6. The telegram analysis method according to claim 5, further comprising a step executed by the telegram analysis apparatus associating a plurality of applications corresponding to the plurality of associated telegrams with each other.

7. The telegram analysis method according to claim 6, further comprising a step executed by the telegram analysis apparatus associating a plurality of newly acquired telegrams with each other on the basis of information of the plurality of associated telegrams.

8. The telegram analysis method according to claim 1, further comprising a step executed by the telegram analysis apparatus centrally displaying a list display, a time-series display, or a detailed display of the associated telegrams on a display screen.

9. A telegram analysis apparatus comprising:
a control unit that analyzes telegrams transmitted and received between a plurality of servers connected via a network apparatus; and
a storage unit that stores an analysis result of the telegrams,
wherein the control unit:
captures packets transmitted and received between the servers;
identifies protocols of the packets and a telegram type indicative of either a request telegram or a response telegram, and assembles the protocols into telegrams; and
associates a plurality of telegrams with each other, which are transmitted and received between the respective servers on the basis of request receipt times and response receipt times of the telegrams.

10. A telegram analysis system comprising:
a plurality of servers connected via a network apparatus; and
a telegram analysis apparatus that captures packets from the network apparatus,
wherein the telegram analysis apparatus:
identifies protocols of the captured packets and a telegram type indicative of either a request telegram or a response telegram, and assembles the protocols into telegrams; and
associates a plurality of telegrams with each other, which are transmitted and received between the respective servers on the basis of request receipt times and response receipt times of the telegrams.
